(19) United States
(12) Patent Application Publication
(10) Pub. No.: US 2011/0018489 A1
(43) Pub. Date: Jan. 27, 2011

(54) Solar R/C (radio control) battery charger

(76) Inventor: Joseph Bedi, SR., Albuquerque, NM (US)

Correspondence Address: JOSEPH BEDI SR. & VIKKI BEDI, PO BOX 90934, ALBUQUERQUE, NM, 87199, US

(21) Appl. No.: 12/454,644

(22) Filed: Jul. 27, 2009

(51) Int. Cl. H01M 10/46

(52) U.S. Cl. 320/101

(57) ABSTRACT

This thin film solar panel with attached wire and a special connectors will charge a battery for R/C (Remote Control) Aircraft, Boat or Car at a voltage of 4.8, 6.0 or 7.2 with a 100 Milliamps

This 6.0 volt Solar R/C (Radio control) battery charger is comprised of A thin film solar panel (FIG. 1 Number 1) that is 4 5/16″ wide and 5¾″ High and 0.080 of an inch thick, that produces 6.0 Volts of DC Voltage at a 100 milliamps per Hour, when the Solar panel is exposed to direct sunlight, with 12 or more inches of 20 to 24 gage stranded wire (red and black) Soldered to the Solar panel, Red on the Positive side and Black on the Negative side as shown on (FIG. 1 Number 2 and 3) The wires are connected to a special connector supplied by the listed manufacturers—(Fataba, J R, Hitec or Z connectors) that are used only for connection to R/C (radio controlled) battery's (FIG. 1 number 4). The Solar panels can be mounted directly by glue or tape to the surface of a radio control airplane, boat, or car to provide charging to the batteries while the radio control airplane, boat or car is not in use. Panels will also discharge the batteries without sunlight on the panels, solar panel should be disconnected from battery without sunlight.

This 4.8 Solar R/C (Radio control) battery charger is comprised of A thin film solar panel (FIG. 2 Number 1) that is 3½″ wide and 5¾″ High and 0.080 of an inch thick, that produces 4.8 Volts of DC Voltage at a 100 milliamps per Hour, when the Solar panel is exposed to direct sunlight, with 12 or more inches of 20 to 24 gage stranded wire (red and black) Soldered to the Solar panel, Red on the Positive side and Black on the Negative side as shown on (FIG. 2 Number 2 and 3) The wires are connected to a special connector supplied by the listed manufacturers—(Fataba, J R, Hitec or Z connectors) that are used only for connection to R/C (radio controlled) battery's (FIG. 2 number 4). The Solar panels can be mounted directly by glue or tape to the surface of a radio control airplane, boat, or car to provide charging to the batteries while the radio control airplane, boat or car is not in use. Panels will also discharge the batteries without sunlight on the panels, solar panel should be disconnected from battery without sunlight.

This 7.2 volt Solar R/C (Radio control) battery charger is comprised of A thin film solar panel (FIG. 3 Number 1) that is 2⅞″ wide and 9¾″ High and 0.080 of an inch thick, that produces 7.2 Volts of DC Voltage at a 100 milliamps per Hour, when the Solar panel is exposed to direct sunlight, with 12 or more inches of 20 to 24 gage stranded wire (red and black) Soldered to the Solar panel, Red on the Positive side and Black on the Negative side as shown on (FIG. 3 Number 2 and 3) The wires are connected to a special connector supplied by the listed manufacturers—(Fataba, J R, Hitec or Z connectors) that are used only for connection to R/C (radio controlled) battery's (FIG. 3 number 4). The Solar panels can be mounted directly by glue or tape to the surface of a radio control airplane, boat, or car to provide charging to the batteries while the radio control airplane, boat or car is not in use. Panels will also discharge the batteries without sunlight on the panels, solar panel should be disconnected from battery without sunlight.

### TECHNICAL FIELD OF THE INVENTION

The present disclosure pertains generally to Solar battery charging for a specific type of battery use (4.8, 6.0, 7.2 volts at a 100 Milliamps) more particularly, for R/C(Remot Control) Aircraft, Boats and Cars, by utilizing the sun capabilities as a power source.

### BACKGROUND OF THE INVENTION

Flying R/C (Remote Control) Aircraft, or playing with a R/C Car or Boat in the past has been a cumbersome task and chore keeping the batteries charged with the use of very heavy batteries and special charging devises used to recharge an R/C battery when they run down. With the R/C Solar Battery charger the need to recharge a battery again with a heavy second larger battery and special charger is over. The Relatively Inexpensive Thin Film Solar panels will keep the batteries charged at the specific voltage needed without the use of another charging medium. This device will also save the person money from not having to charge there batteries in a house charger, plugged into a 115 volt outlet.

### BRIEF DESCRIPTION OF THE DRAWINGS

FIG. 1 a 6.0 volt solar R/C Battery charger with dimensions and numbered description in specifications sheet

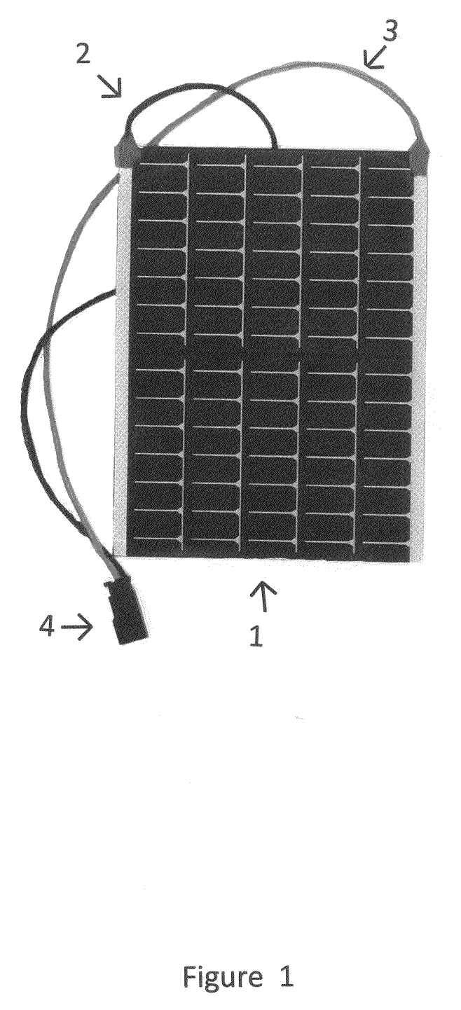

FIG. 2 a 4.8 volt solar R/C Battery charger with dimensions and numbered description in specifications sheet

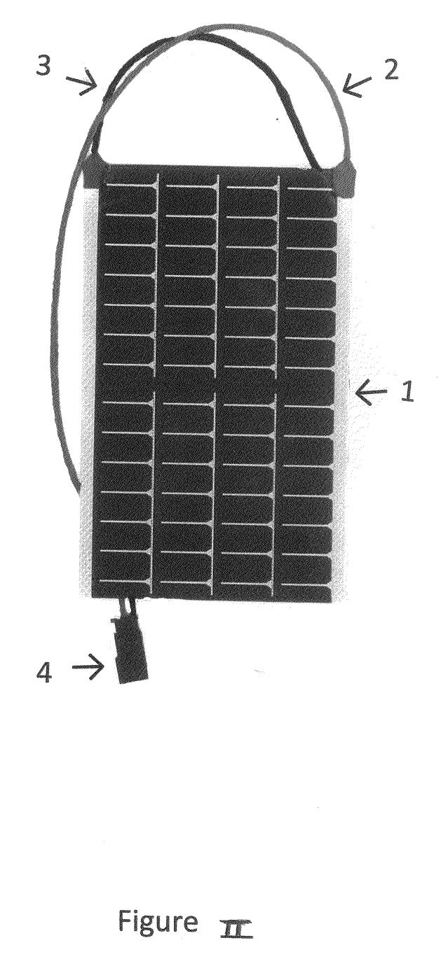

FIG. 3 is a 7.2 volt solar R/C Battery charger with dimensions and numbered description in specifications sheet

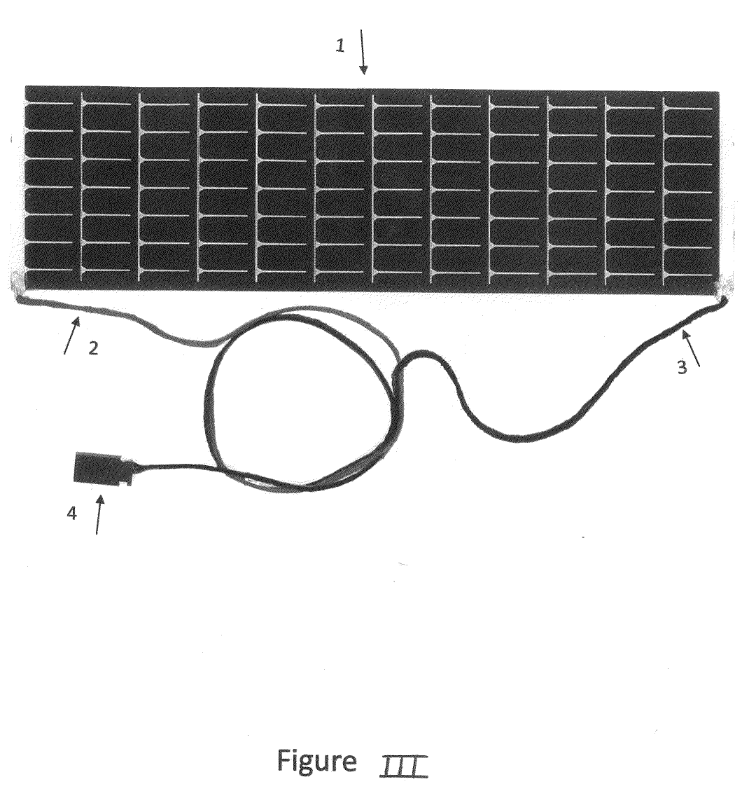

### SUMMARY OF THE INVENTION

The present invention is directed to an innovative method and a very inexpensive and light weight way to charge your R/C (radio control) batteries for your Aircraft, Boat or Car, without having to rely on the power grid, or heavy batteries with voltage reducers to charge your R/C batteries, it also removes all concerns about proper voltage charge.

The invention claimed is:

1. This method of Solar Panel use will charge all R/C (Radio control) battery's for use in a specified voltage (ref # 2) with a radio controlled aircraft car or boat.

2. panel size will determine output, ether 4.8, 6.0 or 7.2 volts at a 100 milliamps per hr.

3. The Solar panels can be mounted directly on the surface of a radio control airplane, boat, or car by method of glue or clear tape.

4. The Solar panel will provide a continual charge to the batteries with direct sunlight, while the radio control airplane, boat or car is not in use.

5. Panels will also discharge the batteries without direct sunlight on the panels, solar panel should be disconnected from battery without sunlight.
